(19) United States
(12) Patent Application Publication
(10) Pub. No.: US 2003/0004779 A1
(43) Pub. Date: Jan. 2, 2003

(54) Method and system for online benchmarking and comparative analyses

(76) Inventors: Arvind Rangaswamy, State College, PA (US); Eric Fedok, Allentown, PA (US)

Correspondence Address: Paul D. Greeley, Esq., Ohlandt, Greeley, Ruggiero & Perle, L.L.P., 10th Floor, One Landmark Square, Stamford, CT, 06901-2682, US

(21) Appl. No.: 09/880,693

(22) Filed: Jun. 13, 2001

(51) Int. Cl. G06F 17/60

(52) U.S. Cl. 705/10

(57) ABSTRACT

A benchmark method and system uses a common and generic XML-based questionnaire design tool and a common data structure for all questionnaires of a plurality of benchmark studies. This allows rapid design of a study and its questionnaire as well as gathering of respondent data online, quick turnaround times for requested benchmark reports and online delivery thereof. One advantageous feature is an instant feedback of comparative data concerning questions the respondent has answered.

### FIELD OF THE INVENTION

This invention relates to a method and system for conducting benchmarking studies.

### BACKGROUND OF THE INVENTION

Many organizations conduct benchmarking studies to improve effectiveness of their processes, such as order management, new product development, customer satisfaction, and the like. Consulting companies collect and sell benchmarking data. Traditionally, benchmarking data has been gathered by personal contact through written or telephone surveys. This process is labor intensive, time consuming and expensive.

Prior benchmarking studies take a considerable time to gather the answer data and process it into meaningful categories for a particular study. Accordingly, a considerable time lapses before a study respondent obtains any benchmark results or reports.

Accordingly, there is a need for a rapid benchmarking data gathering methodology and system.

### SUMMARY OF THE INVENTION

The present invention provides a method and system that is capable of conducting a plurality of benchmarking studies rapidly with quick feedback of benchmark results to the respondents of a study. Interactive sessions are conducted online with respondents of the studies with a questionnaire. The questionnaires of all the studies differ in content and format, but have a common data structure. A database is built with the response data of the questionnaire. Benchmarking reports that utilize the response data are provided upon request.

A file is built for each study populated with the answers of each respondent for that study. Broadly stated, a study file contains the text of the questions, the validation rules, formatting, and names of items to look up in a database. The database includes information on the respondents, what questionnaire they should be completing, what questions are in that questionnaire, what responses are possible, and the actual responses given by the respondents. The study files are organized according to the data structure. During an interactive session, a respondent can be given a feedback of comparative data concerning a question the respondent has answered. This feedback can be instant. The answer data in the study files is processed by keying on the data structure to produce benchmark reports.

According to one aspect of the invention, the data structure includes a question element that has question attributes and an answer element that has answer attributes. The study files are organized and processed according to these question elements and answer elements. The common data structure of the questionnaires has a number of important advantages. The questionnaires of different studies can be rapidly designed as to content and format according to the common data structure. The study files can be built and populated with answer data and processed for benchmark reports by programs that do not need to be changed from one study to another.

The present invention satisfies the aforementioned need with an online method and system that gathers benchmarking data and provides benchmark results or reports via a network, such as the Internet, the World Wide Web (Web), or other communication network Thus, the method and system of the present invention greatly simplifies the collection of benchmarking data, and, at the same time, enhances the value thereof.

### BRIEF DESCRIPTION OF THE DRAWINGS

Other and further objects, advantages and features of the present invention will be understood by reference to the following specification in conjunction with the accompanying drawings, in which like reference characters denote like elements of structure and:

FIG. 1 is a block diagram of a system that includes the benchmarking system of the present invention;

FIG. 2 is a block diagram of the computer of the FIG. 1 system;

FIGS. 3-6 depict various question and answer styles for a standardized questionnaire for the programs of the computer of FIG. 2;

FIG. 7 is a flow diagram for the benchmark study program of the computer of FIG. 2;

FIG. 8 is a flow diagram for the file builder program of the computer of FIG. 2;

FIG. 9 is a flow diagram for the benchmark analysis program of the computer of FIG. 2; and

FIG. 10 depicts a data structure for benchmarking system of FIG. 1.

### DESCRIPTION OF THE PREFERRED EMBODIMENT

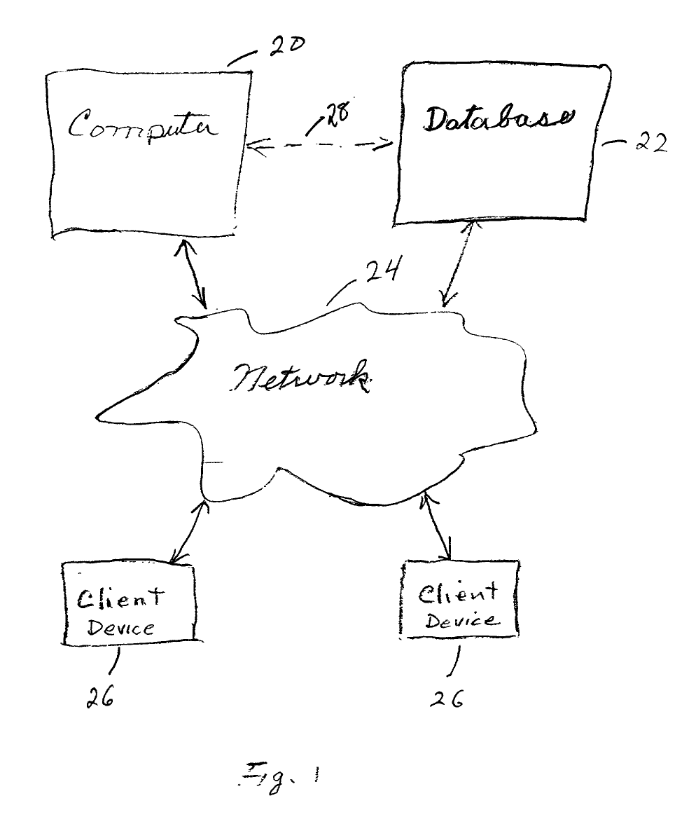

With reference to FIG. 1, a computer 20 is interconnected via a network 24 with a database 22 and a plurality of client devices 26. Computer 20 may also communicate directly with database 22 as shown by a dashed line 28 in FIG. 1. Computer 20 may be any computer, known presently or in the future, that has a capability of communicating via network 24. Computer 20 may be a single computer or several computers connected in a distributed computing system via network 24 or via a local area network (not shown). Database 22 may be any database and may be a single database or a plurality of databases. Network 24 may be any network, known presently or in the future, such as an Internet, an Intranet, a World Wide Web (Web) or the like. Network 24 may include wired, wireless, and/or satellite links and the like. Client devices 26 may be any devices, known presently or in the future, such as a personal computer, a telephone, a hand held computing device or other device with a browser capability for communicating via network 24 with computer 20.

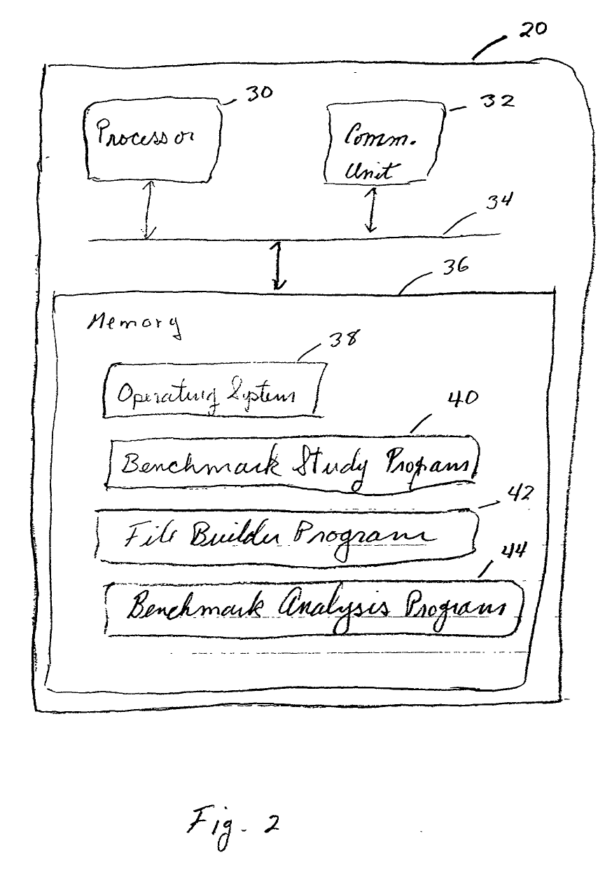

Referring to FIG. 2, computer 20 includes a processor 30, a communications unit 32 and a memory interconnected via a bus 34. Memory 36 includes an operating system 38, a benchmark study program 40, file builder program 42 and a benchmark analysis program 44. Operating system 38 includes the necessary code to cause processor 30 to execute benchmark study program 40, file builder program 42 and benchmark analysis program 44 and to communicate via communications unit 32 and network 24 with client devices 26. Alternatively, online sessions can be conducted directly with client devices 26 without using network 24.

According to the present invention, computer 20 runs benchmark study program 40, file builder program 42 and benchmark analysis program 44 to conduct benchmark studies, build files for the studies and provide benchmark analysis reports. The questionnaires of each study differ from those of other studies in content and format, but employ a standardized data structure. The standardized data structure provides the important advantages of ease in designing a questionnaire, the use of the same benchmark study program 40, file builder program 42 and benchmark analysis program 44 for all of the studies and the rapid launch of new benchmark studies. This greatly simplifies the conduct of benchmark studies.

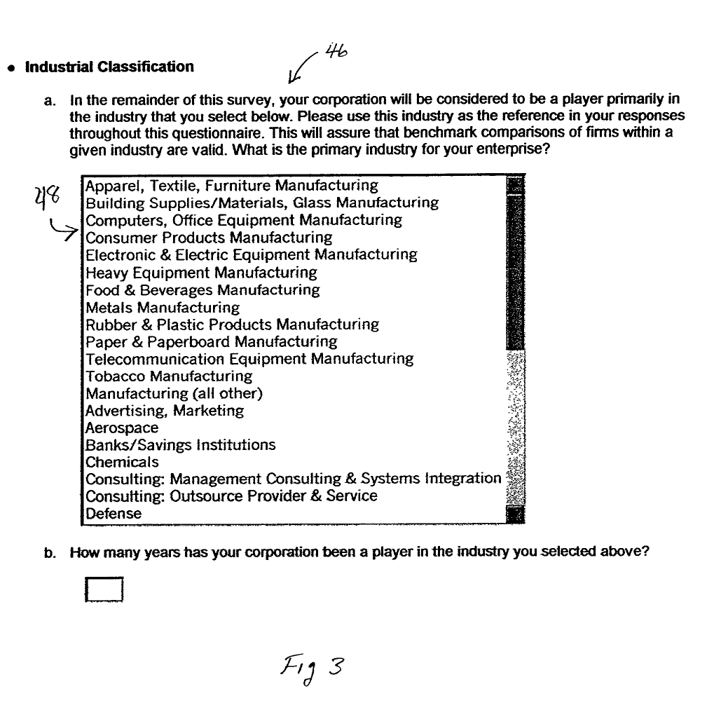

Referring to FIGS. 3-6, a number of sample question styles for a typical questionnaire are shown. Referring first to FIG. 3, a category style question 46 asks a respondent to identify from a list 48 a business category for the respondent's company.

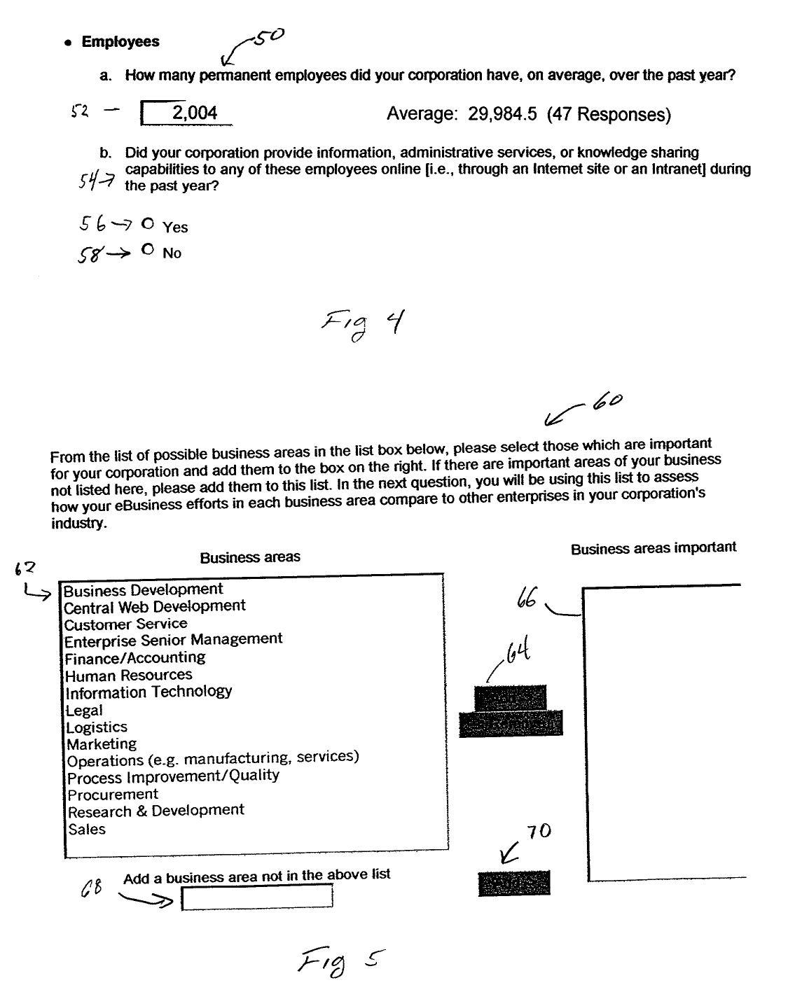

Referring to FIG. 4, a box style question 50 has an answer box 52. According to an aspect of the invention, a respondent is given instant feedback after completing the questionnaire. Thus, box style question 50 asks the respondent to insert in box 52 the number of employees the respondent's company had over the past year. The respondent enters number “2,004”. At the end of the study, benchmark study program 40 responds by presenting the respondent with an average of “29,984.5” for a response of 47 respondents. This type of instant feedback is advantageous as it can be immediately seen how respondent's company stacks up against other respondent companies in the business area identified for category style question 46 of FIG. 3. Still referring to FIG. 4, a check style question 54 includes check boxes 54 and 56 for the respondent to indicate a yes or no answer. Another aspect is that benchmark study program 40 provides benchmark results only for the questions that the respondent answers. This serves as an incentive to the respondent to answer the questions fully and accurately.

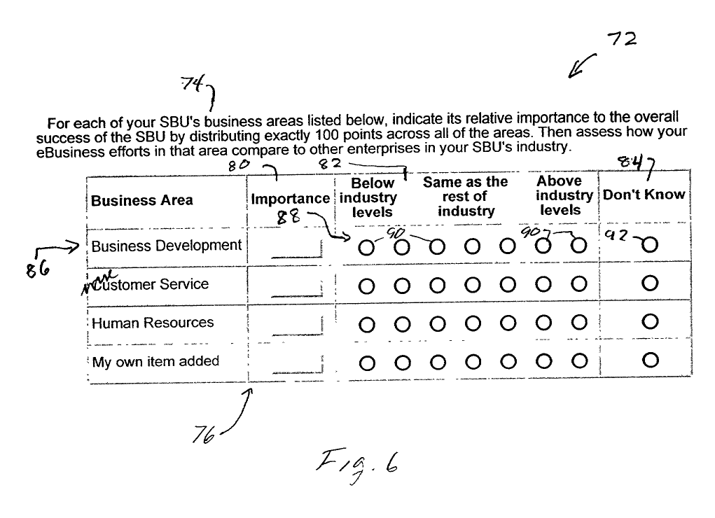

Referring to FIG. 5, a category style question 60 has a list of categories 62 from which the respondent is to select one or more categories of business areas. When selected, the respondent activates an add button 64 to display the selected categories in an important business areas box 66. A remove button allows the respondent to remove a business area from important business areas box if there is a change of mind. An add business area box 68 allows the respondent to add a business area not included in list 62. The entered business area is transferred from add business area box 68 to business area box 66 by operation of an add button 70.

Referring to FIG. 6, a categorized response style question 72 has a question element 74 and an answer element 76. Answer element 76 is shown as a table that includes a column 78 of business area categories (selected, for example, from business area list 62 of FIG. 5) and answer columns 80, 82 and 84. Question element 74 asks the respondent to rank the business area categories of column 78 by relative importance to the success of respondent's company in answer column 80. Question element 74 also asks the respondent to rate respondent's company for each business category over a range that extends from below industry levels at one end to above industry levels at the other end. For example, the business development category row 86 has a range 88 with seven boxes 90. If the respondent doesn't know the relative industry ranking, a box 92 in answer column 84 is checked.

The questionnaires of the various studies can use one or more of the above question styles or other styles. The questionnaires of the various studies share a common data structure. The data structure has question elements and answer elements. A question element has various attributes that together with the necessity thereof are set forth in Table 1 below.

TABLE 1

| Question Element Attributes | Necessity |
|---|---|
| Question text | Optional |
| Verify group | Optional |
| Answer or Categorized Responses | Required |

An example of a question text attribute is question element 74 in FIG. 6. An example of an answer attribute is answer box 52 of question 50 in FIG. 4. Answer element 76 in FIG. 6 is an example of a categorized response attribute and also of a verify group element. The only question attribute that is required is either an answer attribute or a categorized responses attribute. The other attributes are optional.

The verify group attribute is generally used together with the categorized responses attribute. An example is when all answers in a question must total to a certain number, such as the ranking for answer column 80 of FIG. 6. A verify group attribute has a name, a test value and a user description. The name of the verify group attribute is unique (relative to other verify groups in the questionnaire). An example of a name is “importance” in column 80 of FIG. 6. The test value of the verify group attribute is the total sum value, which is 100 for the categorized responses style question 72 in FIG. 6. The user description attribute for the verify group is a description given to the user if the responses do not meet the verification test. For example, the user description attribute is part of the text in an error message dialog box that is presented to the respondent. After the respondent closes the dialog box, a red flag appears next to the question that caused the problem.

The data structure answer elements must have either a text box response part, a single choice part, a multiple-choice part, or a Boolean response part. Also, an answer element will have zero or more verify group parts. Verify single indicates that any given response must meet certain rules (e.g., between 0 and 100). Verify group indicates that a set of responses share a common rule (e.g., they must add up to 100). Verify single and verify group are optional elements. On the other hand, text, single choice, multiple choice and Boolean specify the kind of answer expected and are required elements. An example of a text box response part is answer box 52 of question style 50 in FIG. 4. An example of a multiple-choice part is question 54 (FIG. 4) that has multiple-choice boxes 56 and 58. Boxes 56 and 58 are also an example of a Boolean response part. An example of a verify single part is box 52 (FIG. 4). The respondent is not permitted to enter a negative number.

An answer element has several attributes, which are set forth with the necessity thereof in Table 2 below.

TABLE 2

| Answer Element Attributes | Necessity |
|---|---|
| Actual check | Optional |
| Verify group | Optional |
| Data type (text, money, integer, | Required |
| decimal, resource) | |
| Units | Optional |
| Decimal places | Optional |
| Answer description | Required |

The actual check attribute is optional and indicates whether there will be a check box to indicate if the response is actual or estimated. The verify group attribute indicates which verify group this response is in. The data type attribute indicates what kind of data is expected in this response. The units attribute indicates if the answer is in currency, a percentage or other units. The decimal places attribute indicates how many decimal places are allowed for this answer. The answer description attribute is the unique name of the answer and must be supplied in order to properly record the answer in database 22.

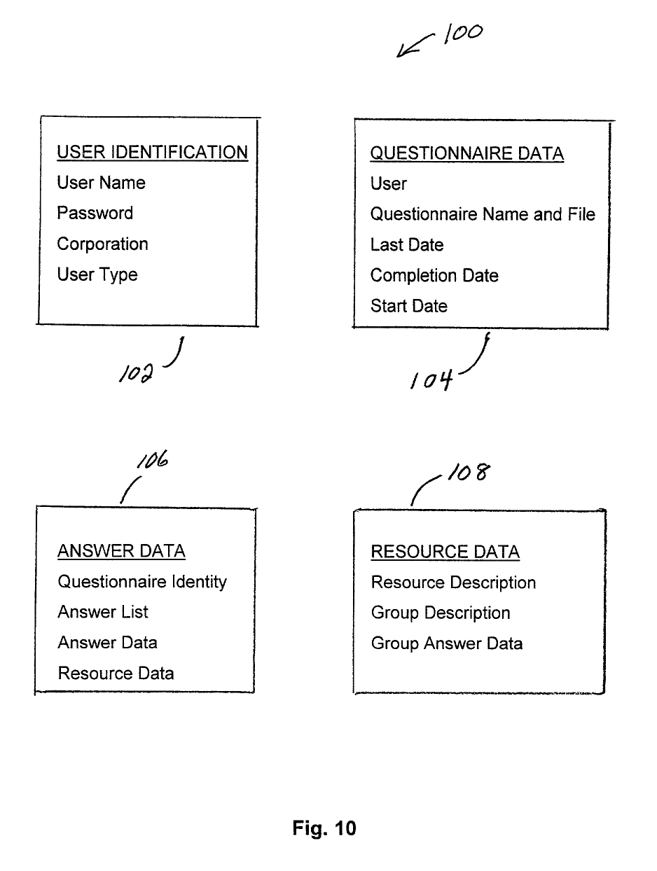

Referring to FIG. 10, a data structure 100 is shown for the questionnaire and response data for the benchmark studies. Data structure 100 includes a user identification table 102, a questionnaire data table 104, an answer data table 106 and a resource data table 108. User identification table 102 includes data for the authentication of a user, such as user name, password, corporation (and subsidiary or division) that user represents and user type (e.g., enterprise, administrator and the like). Questionnaire data table 104 includes questionnaire data, such as user identification, questionnaire name and file for that user, last date of answer entries, completion date and start date. Answer data table includes answer data, such as the questionnaire identity, and answer list for that questionnaire, raw answer data for the questionnaire and resource data. Resource data table 108 includes resource information, such as resource description, group description and group answer data. For example, resource data table 108 contains answer data (or pointers thereto) for categorized response answers, verify group answers and the like, for the respondents of the group of which the user is a member. The group is identified by the respondent's answer to category style question 46 (FIG. 3).

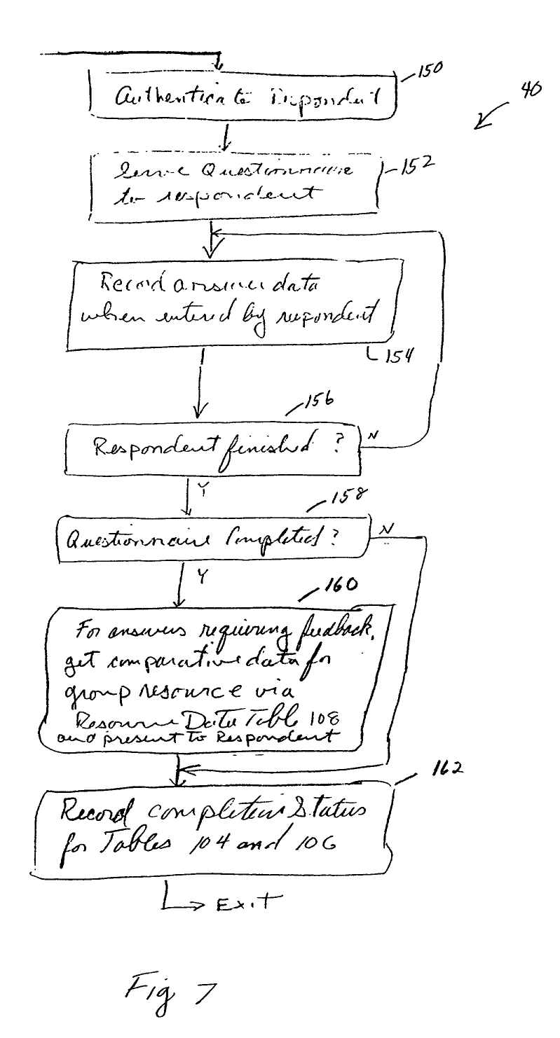

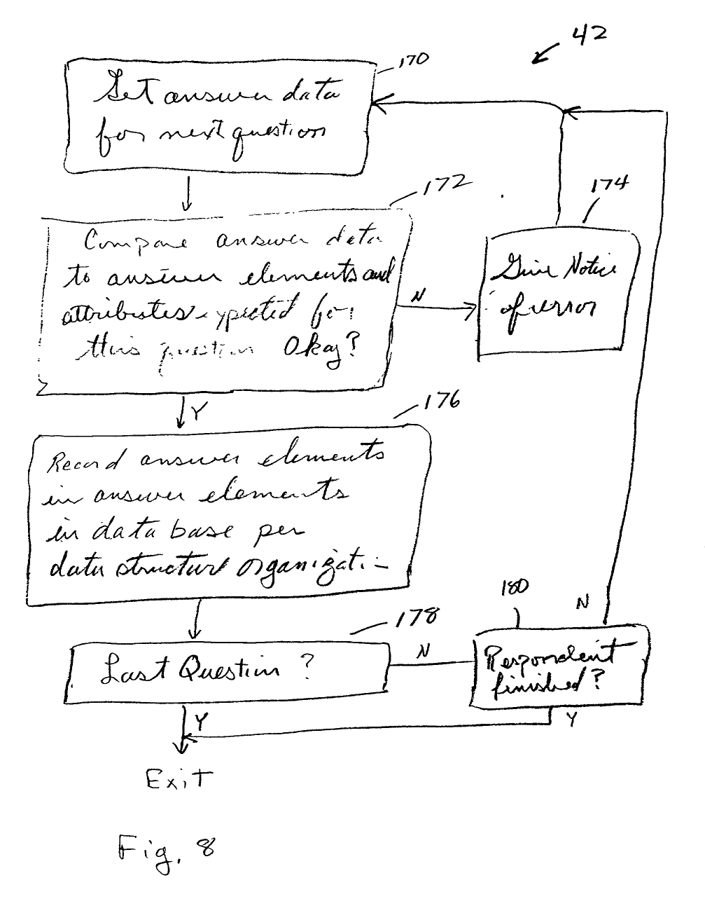

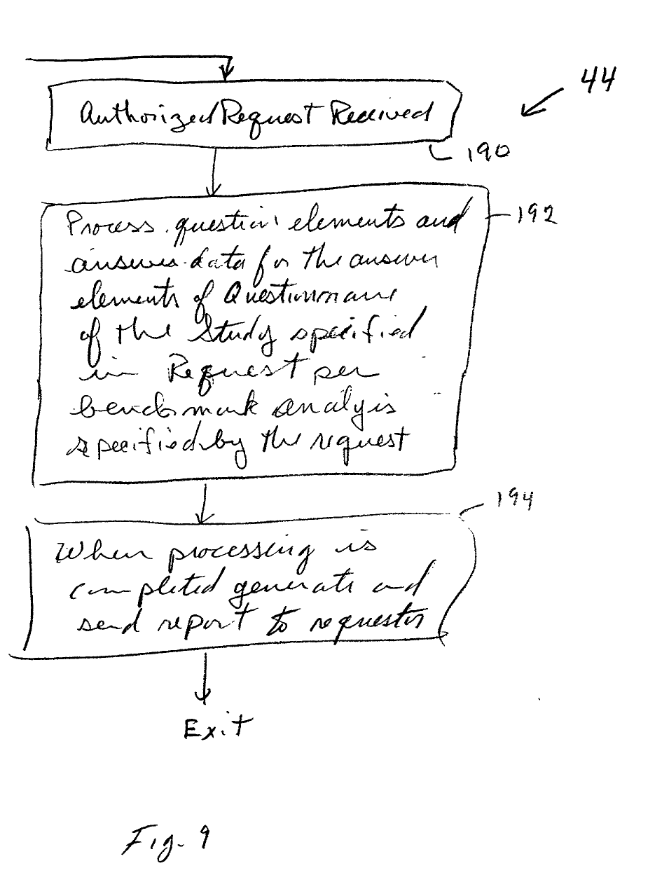

Referring to FIG. 7, benchmark study program 40 begins an interactive session with a respondent at step 150, which authenticates the respondent for a study. When the respondent has been authenticated, step 152 serves the questionnaire for the study to the respondent. Step 154 records the answer data when entered by the respondent. Step 156 determines if the respondent is finished. If not, step 154 is repeated. If yes, step 158 determines if the questionnaire has been completed. If yes, step 160 determines if any answers require feedback and, if so, gets comparative data via resource data table 108 and presents it to the respondent, as for question 50 in FIG. 4. When the comparative data has been presented, or if no comparative data is required or if step 158 determines the questionnaire is not yet completed, step 162 records completion status for tables 104 and 106 and benchmark study program 40 is then exited. The respondent is finished when all expected answer data of the questionnaire has been entered or earlier if the respondent signs off before completion. If earlier, step 162 records the incomplete status for this respondent so that work on the questionnaire may be retrieved if the respondent later desires to resume.

Referring to FIG. 8, file builder program 42 begins with step 170 getting answer data for the next question. Step 172 compares the answer data with the answer elements and attributes that are expected for the current question. If not okay, step 174 gives notice of the error. This notice can be sent to the respondent by step 174 or by benchmark program 40 dependent on the design of the software system. If step 172 finds that the answer data is okay, step 176 records the answer elements in the database according to the data structure organization. Step 178 determines if the current question is the last one. If not, step 180 determines if the respondent is finished (finished without completion). If not, steps 170-178 are repeated. When either step 178 determines the last question has been answered or step 180 determines that the respondent is finished, file builder program 42 is exited.

Referring to FIG. 9, benchmark analysis program 44 begins with step 190 determining that an authorized request has been received. Step 192 then processes the question element and answer element data of the study file in accordance with the requested analysis. When step 192 completes the processing, step 194 generates and sends a benchmark report to the requestor.

It will be apparent to those skilled in the art that although benchmark study program 40, file builder program 42 and benchmark analysis program are shown as separate program entities, they may be integrated into a lesser number of programs or split into a greater number of programs. Also those skilled in the art will appreciate that the file for a study can reside in whole or in part in a cache of computer 20 and/or solely in database 22.

The present invention having been thus described with particular reference to the preferred forms thereof, it will be obvious that various changes and modifications may be made therein without departing from the spirit and scope of the present invention as defined in the appended claims.

What is claimed is:

1. A method for providing benchmarking comprising:
(a) conducting online interactive sessions with a plurality of respondents who supply response data to one or more benchmarking questions of a questionnaire;
(b) building a database with said response data of said respondents; and
(c) providing benchmarking reports that utilize said response data upon a request.

2. The method of claim 1, wherein step (c) provides said benchmarking reports online.

3. The method of claim 1, wherein step (c) provides said benchmarking reports only if said request is made by an authorized requestor.

4. The method of claim 1, further comprising: (d) providing online instant feedback to one of said respondents.

5. The method of claim 4, wherein said instant feed back is provided only when the questionnaire is completed.

6. The method of claim 4, wherein said instant feedback includes comparative data of the responses of said one respondent relative to responses submitted by others of said respondents.

7. The method of claim 1, further comprising: (e) during a first one of said sessions, saving a partially completed set of answers to said questionnaire, and (f) presenting said partially completed set of answers in a subsequent second one of said sessions.

8. The method of claim 7, wherein said first and second sessions are conducted with the same respondent.

9. A method for conducting a plurality of benchmarking studies comprising:
(a) conducting interactive sessions with respondents for each of said studies with a questionnaire, wherein the questionnaires of different ones of the studies (i) differ in content and format and (ii) have a common data structure;
(b) building a file for each study with the answers of each respondent for that study, wherein each file is organized according to said data structure;
(c) providing to a first respondent of a first one of said studies during said interactive session a feedback of comparative data from the file for said first study concerning a question said first respondent has answered; and
(d) processing the answer data in said files by keying on said data structure to produce benchmark reports.

10. The method of claim 9, wherein said feedback occurs just after said first respondent completes the questionnaire.

11. The method of claim 9, wherein said data structure includes a question element that has question attributes and an answer element that has answer attributes.

12. The method of claim 11, wherein said question attributes include an answer attribute.

13. The method of claim 12 wherein said question attributes include a categorized response attribute.

14. The method of claim 13, wherein said question attributes include a verify group attribute.

15. The method of claim 14, wherein said verify group attribute has a name, a test value and a user description.

16. The method of claim 12, wherein said question attributes optionally include a question text attribute.

17. The method of claim 11, wherein said answer attributes include a data type and an answer description.

18. The method of claim 17, wherein said answer attributes further include one of more members of the group consisting of actual check, verify group, decimal places and units.

19. The method of claim 11, wherein the files built by step (b) are organized by said question element and said question attributes and by said answer element and said answer attributes.

20. The method of claim 19, wherein said answer data in said files is processed by step (d) according to said question element and said question attributes and by said answer element and said answer attributes.

21. A system for conducting a plurality of benchmarking studies comprising:
a computer having a processor;
first means for causing said processor to perform a first operation of conducting interactive sessions with respondents for each of said studies with a questionnaire, wherein the questionnaires of different ones of the studies (i) differ in content and format and (ii) have a common data structure;
second means for causing said processor to perform a second operation of building a file for each study with the answers of each respondent for that study, wherein each file is organized according to said data structure;
third means for causing said processor to perform a third operation of providing to a first respondent of a first one of said studies during said interactive session a feedback of comparative data from the file for said first study concerning a question said first respondent has answered; and
fourth means for causing said processor to perform a fourth operation of processing the answer data in said files by keying on said data structure to produce benchmark reports.

22. A memory media for controlling a computer that conducts benchmarking studies, said memory media comprising:
first means for controlling said computer to perform a first operation of conducting interactive sessions with respondents for each of said studies with a questionnaire, wherein the questionnaires of different ones of the studies (i) differ in content and format and (ii) have a common data structure;
second means for controlling said computer to perform a second operation of building a file for each study with the answers of each respondent for that study, wherein each file is organized according to said data structure;
third means for controlling said computer to perform a third operation of providing to a first respondent of a first one of said studies during said interactive session a feedback of comparative data from the file for said first study concerning a question said first respondent has answered; and
fourth means for controlling said computer to perform a fourth operation of processing the answer data in said files by keying on said data structure to produce benchmark reports.
